(19) United States
(12) Patent Application Publication
(10) Pub. No.: US 2018/0063011 A1
(43) Pub. Date: Mar. 1, 2018

(54) Media Buffering

(71) Applicant: Microsoft Technology Licensing, LLC, Redmond, WA (US)

(72) Inventors: Ulf Nils Evert Hammarqvist, Stockholm (SE); Karsten V. Sørensen, Stockholm (SE)

(73) Assignee: Microsoft Technology Licensing, LLC, Redmond, WA (US)

(21) Appl. No.: 15/338,955

(22) Filed: Oct. 31, 2016

(30) Foreign Application Priority Data
Aug. 24, 2016 (GB) 1614452.9

(51) Int. Cl. H04L 12/805; H04L 29/06; H04L 12/927

(52) U.S. Cl. CPC H04L 47/365; H04L 47/801; H04L 65/4069

(57) ABSTRACT

A transmitting device comprising a buffer for buffering data representing a live media stream to be packetized, and a controller configured to packetize the live media stream from the buffer for processing and then transmission over a network. The live media stream to be packetized comprises one or more samples or frames of live media stream data, and each of the packets contain one or more of the samples or frames of live media stream data. The controller is further configured to measure the amount of data buffered in the buffer and to adapt the size of the packets in dependence on the measured amount.

### PRIORITY

This application claims priority under 35 USC 119 or 365 to Great Britain Application No. 1614452.9 filed Aug. 24, 2016, the disclosure of which is hereby incorporated by reference in its entirety.

### BACKGROUND

Communications networks are being increasingly used for real-time communications such as voice and video communication. In such fields it becomes more important that the data transmitted, making up the content of such communications, arrives at the correct time within the communication data sequence, e.g. within the conversation. Some communications networks and transport networks are designed to value error free delivery of data over timely delivery of data, whereas other networks prioritize timely delivery of data above error free delivery of data. When communications are sent using protocols designed to prioritize timely delivery of data, it can often be difficult for the receiving terminal of the communication data to assess whether data packets are arriving late within the sequence due to delays at the transmitter, or due to delays in the network itself. To account for these delays many receivers possess a buffer, referred to as a jitter buffer, for storing received data packets before further processing the content of these packets into an audible communication for playout. This allows the receiver to wait some amount of time in the hope of receiving the delayed data before the data being played out reaches the point in the sequence where it requires the audio data yet to be received.

Some jitter buffers are configured with an adaptive mechanism whereby, when the receiver receives a packet which it perceives as being delayed, the length of the delay of the jitter buffer is increased, to allow more time for the delayed packet to be received. However, this results in artificial pauses in the audible communication, and can result in the parties of the communication perceiving this delay, for example resulting in the parties talking over each other.

### SUMMARY

It has been recognised that during live media stream playout, buffers used to store media stream data prior to packetization can accumulate data. This accumulation is often due to internal processing stalls such as thread and central processor stalls. During the stall the buffered live media stream data can build up in the buffer to an amount that would serve as payload for multiple packets. When faced with multiple packets to encode there is a latency cost due to the need to add header information to each of the payloads to form packets. It has been noticed that where otherwise smaller packets are used to minimise the latency introduced by waiting for an amount of data to accumulate for the packet payload, in the above mentioned situation there is already ample data buffered for the smaller payload. It is therefore noticed that the additional latency of using larger payloads does not occur in this situation and the bandwidth cost of adding multiple headers to multiple payloads can be avoided by adapting the payload size of the packet to accommodate more of the buffered data.

Various embodiments disclosed herein provide a transmitting device comprising a buffer and a controller. The buffer operating to buffer data representing a live media stream while it waits to be packetized. The controller serves to packetize the live media stream from the buffer for processing and then transmission over a network. The live media stream to be packetized comprises one or more sample or frames of live media stream data. The controller is configured to measure the amount of data buffered in the buffer and adapt the size of the packets in dependence on the measured amount.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the present invention and to show how the same may be put into effect, reference will now be made, by way of example, to the following drawings in which:

FIG. 1 shows a schematic illustration of a communication network comprising multiple services each with a respective user network of multiple users and user terminals;

FIG. 2 shows a schematic block diagram of a user terminal;

FIG. 3 shows a flow chart for a process of adapting the size of a packet depending on the amount of data buffered in a buffer; and

FIGS. 4a and 4b show schematic diagrams of the adapting of the packet size.

### DETAILED DESCRIPTION

In the following description, numerous specific details are set forth to provide a more thorough understanding of the described embodiments. However, it will be apparent to one of skill in the art that the described embodiments may be practiced without one or more of these specific details. In other instances, well-known features have not been described in order to avoid obscuring the described embodiments.

Reference throughout this disclosure to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In a communication system a communication network is provided, which can link together two communication terminals so that the terminals can send information to each other in a call or other communication event. Information may include speech, text, images or video.

Modern communication systems are based on the transmission of digital signals. Analogue information such as speech is input into an analogue to digital converter at the transmitter of one terminal and converted into a digital signal. The digital signal is then encoded and placed in data packets for transmission over a channel to the receiver of another terminal.

Each data packet includes a header portion and a payload portion. The header portion of the data packet contains data for transmitting and processing the data packet. This information may include an identification number and source address that uniquely identifies the packet, a header checksum used to detect processing errors and the destination address. The header may also include a timestamp signifying the time of creation of the data in the payload as well as a sequence number signifying the position in the sequence of data packets created where that particular packet belongs. The payload portion of the data packet includes information from the digital signal intended for transmission. This information may be included in the payload as encoded frames such as voice or audio frames, wherein each frame represents a portion of the analogue signal. Typically, each frame comprises a portion of the analogue signal measuring 20 milliseconds in length. However, this should be understood to be a design choice of the system being used and thus can be any chosen division of the analogue signal either longer and/or shorter than 20 milliseconds.

Degradations in the channel on which the information is sent will affect the information received at the receiver. Degradations in the channel can cause changes in the packet sequence, delay the arrival of some packets at the receiver and cause the loss or dropping of other packets. The degradations may be caused by channel imperfections, noise and overload in the channel. Degradations in the communication experience can also be caused by delay is transmission of data packets at the transmitter. This is particularly likely when receivers are designed to adapt dynamically to perceived delays in the received data packets. It can be difficult for the receiver to determine whether the measured delay in the arrival of a packet at the receive side is due to degradation in the channel due to the network or simple a delay in sending the data at the transmitter side. Some network protocols are able to provide side information to inform the receiver of what kind of delay is happening, and some receivers are configured to take action in response to this side information. However not all network protocols, especially those used in for real-time communications, are able to do include this information. Furthermore, not all receivers are capable of using this information even if provided. When the receiver cannot determine the nature of the delay from side information the solution is to treat all delays as though they are caused by the network, i.e. to respond by adjusting the buffer length at the receiver which stores all incoming data packets prior to unpacking and further processing. This buffer is commonly referred to as a jitter buffer.

A jitter buffer is used by a receiving terminal in a network to provide a waiting period over which delayed data packets can be received. This allows the receiving terminal to play out the received data packets to the receive side user in the correct order and at the correct time relative to each other. The jitter buffer thus prevents the audio signal played out at the receive side from being artificially compressed or broken up depending on the time of arrival of the data packets at the receiving terminal. When a delay is detected the receiver can extend the length of the delay of its jitter buffer to give the delayed packet more time to arrive in time to be placed correctly in the sequence of audio data before being played out. However, this can result in more artificial delay being introduced into the audio signal while awaiting the delayed data packet, and the result may be a noticeable overlap and mismatch in the conversation of the two-way communication session. Such adjustment of the jitter buffer in response to a processing type delay at the transmit side, which is likely to be temporary and at irregular intervals, is not desirable in a real-time communication scenario. This is because jitter buffers are designed to account for more constant and slowly attenuating changes in delay due to network conditions and as such can be slow to re-adjust back to a shorted length when possible. It would therefore be preferable to avoid the extension of the jitter buffer in response to any short term delays in packet transmission, e.g. due to CPU stalls and/or thread stalls.

CPU stalls and thread stalls occur when a process running on the CPU stops or is stopped. Some processors operate what is known as multithreading or multithreaded processing. In this type of processing the CPU or a single core of a multi-core processor can execute multiple processes or threads concurrently. The term process can also be used as an umbrella term to describe a whole process comprising multiple threads. For example, a communication client executing on the OS may require the CPU to execute the process of carrying out a call, but this may comprise multiple threads including for example the capturing of raw audio data via the microphone, as well as processing that data through to a network interface with a destination address etc. In multithreading each thread that runs concurrently on the CPU or core shares the resources of that core or CPU. A thread may run on the CPU when it is considered ready to run, and share the resources with any other thread which is also ready to run. However, a thread may stall in its execution of its task, e.g. by experiencing a cache miss. In this case another thread may use the available resources to continue in its task and the CPU performs overall in a more efficient way. This is because the threads that are executed simultaneously will utilize any unused resource due to the stalling of another thread. These threads may also be given priorities, and when CPU resources might be needed elsewhere one of the threads running may be dropped before or in preference to another of the threads running. This depends on the task the thread carries out and the programmed priority of that task to the whole process being carried out. For example, during the process of carrying out a voice call there may exist a thread being executed responsible for capturing the live audio data from the microphone, and a thread responsible for packetizing that data for application, transport, and/or network layer processes. During a real-time call the capture of the raw data performed in the first thread will be prioritized over the reading from the buffer and further processing of this data in the second thread. This is because the contemporaneous nature of the live audio data and its sensitivity to intermittent error when it comes to comprehension requires there to be as few gaps in its capture as possible. Whereas the further processing may be able to account for small delays in the transmission of packets due to stalls using a number of available techniques. Thus if the CPU should require resources to be freed up for a further third process, the lowest priority thread of the first and second thread might be allowed to stall in preference to the other. In this case the second thread of processing the captured audio data would be allowed to stall, but the microphone would continue to capture the live audio data via the first thread.

It may also be the case that the software controlling the capture of the live media stream data into the buffer, and/or the further processing of the buffered data, is running in the background. Running software in the background means that the client application is still active and ready to run but is not currently being actively used by the user of the device. For example, the application or client may not be being interacted with via a user interface of the terminal, or it may not be visible to the user of the user terminal. When client applications run in the background it is likely that the associated threads are running slower than when the client application is running in the foreground.

One type of communication network suitable for transmitting digital information is the internet. Protocols which are used to carry voice signals over an Internet Protocol network are commonly referred to as Voice over IP (VoIP). VoIP is the routing of voice conversations over the Internet or through any other IP-based network.

Real-time Transport Protocol (RTP) is a protocol which provides end-to-end network transport functions suitable for applications transmitting real-time data, such as audio, video or simulation data, over multicast or unicast network services. RTP does not address resource reservation and does not guarantee quality-of-service for real-time services. The data transport is augmented by a control protocol (RTCP) to allow monitoring of the data delivery in a manner scalable to large multicast networks, and to provide minimal control and identification functionality. RTP and RTCP are designed to be independent of the underlying transport and network layers. RTP supports the use of sequence numbers and timestamps. The sequence number increments by one for each RTP data packet sent, and may be used by the receiver to detect packet loss and to restore packet sequence. The timestamp reflects the sampling instant of the first octet in the RTP data packet. The sampling instant must be derived from a clock that increments monotonically and linearly in time to allow synchronization and jitter calculations. Some underlying protocols (i.e. some network protocols), may require an encapsulation of the RTP packet to be defined. Typically, one packet of the underlying protocol contains a single RTP packet, but several RTP packets may be contained if permitted by the encapsulation method.

When packetizing data it is important that header information is added to the payload. This information includes a variety of values as discussed above. The process of attaching the header information takes a certain amount of time and processing power to do. This is often referred to as the header overhead. The header overhead is the cost in processing and/or time of adding the header information to the packet's payload. Thus by reducing the header overhead the network load is also reduced.

The inventors have noticed that when buffering data for packetization it can be measured how much data is currently in the buffer and awaiting packetization. This amount of data would typically be split into standard payload amounts and formed into packets. The size of this payload is dependent upon the codec being used. It has been further noticed that by using information on how much data has been buffered and is awaiting packetization it can be determined that there is enough data buffered to form multiple payloads. Knowing this the codec can be configured to allow adaptation of the size of the packets. Allowing the codec to produce a single packet with a payload corresponding to what otherwise would have been the payload of a plurality of separate packets. Thus the data of e.g. three packets can become the payload of a single packet with a single instance of header overhead. The header overhead of the following two packets that it would normally have cost the processor to send the same amount of information is thus saved. Only one portion of header overhead is used to send the whole payload.

For a transmit terminal with a high CPU load it can happen that a buffer is not regularly emptied. Samples or frames can thus accumulate in the buffer, awaiting processing time for being encoded to payloads that will be sent over a network. By adapting the codec payload in response to the amount of data available for encoding, i.e. the buffered number of samples or frames, the packetization header overhead can be reduced. This is done without the usual increase in latency as discussed above, as the latency is already increased due to the accumulation of samples or frames in the buffer.

With respect to thread stalls it can be appreciated that if the encoder thread stalls the transmitter side may unintentionally have a large build-up of unencoded data in the buffer. Once the encoder or packetizer thread begins to run again, if uninformed, the encoder would continue to packetize with payloads of the same size as before, and a packet train would be created. If informed about the amount of media stream data buffered in the buffer the encoder or packetizer can create one or more packets with bigger payloads. Ultimately this would lead to a more efficient use of network bandwidth for this packetized portion of live media stream.

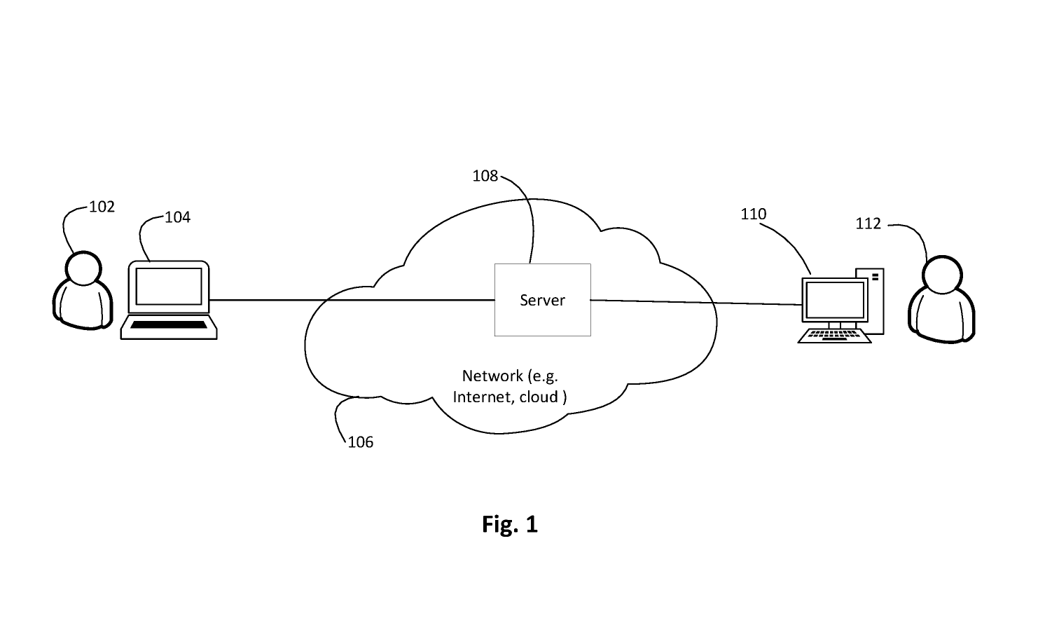

FIG. 1 shows a communication system comprising a user 102 (e.g. the near end user of the system), a user terminal 104 (e.g. a laptop device etc.), a network 106 (e.g. the Internet, the cloud, or any other network through which communication messages and digital data may be sent), a server 108, and a further user 112 of a further user terminal 110 (e.g. the receiving terminal of the communication event).

The near end user, user 102, is the user of user terminal 104. User terminal 104 is connected to network 106. The connection is such that it enables communication (e.g. audio or video or some other such communication type), via network 106. Server 108 is a server of the network 106 and may be distributed throughout the network, in one or more physical locations, and as software, hardware, or any combination thereof.

The source terminal 104 is arranged to transmit data to the destination terminal 110 via the communication network 106. In one embodiment of the invention the communications network is a VoIP network provided by the internet. It should be appreciated that even though the exemplifying communications system shown and described in more detail herein uses the terminology of a VoIP network, embodiments of the present invention can be used in any other suitable communication system that facilitates the transfer of data. Embodiments of the invention are particularly suited to asynchronous communication networks.

It should be appreciated that even though the exemplifying communications system shown and described in more detail herein stipulates a transmitting terminal and a receiving terminal, each of these terminals can also perform the reciprocal actions so as to provide a two-way communication link.

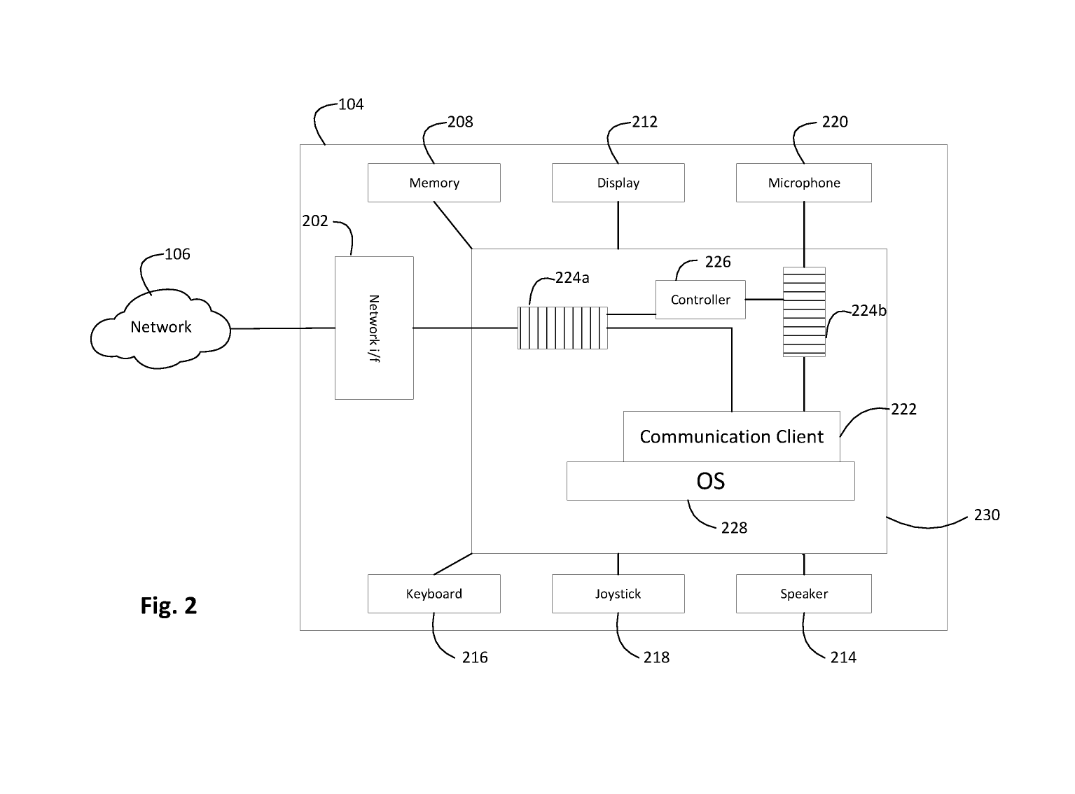

FIG. 2 shows a schematic of a user terminal 104. User terminal 104 comprises a central processing unit, CPU or processing module 230, the CPU runs the processes required to operate the user terminal and includes the operating system, OS 228. The OS may be of any type, for example Windows™, Mac OS™ or Linux™. The CPU is connected to a variety of input and output components including a display 212, a speaker 214, a keyboard 216, a joystick 218, and a microphone 220. A memory component 208 for storing data is connected to the CPU. A network interface 202 is also connected to the CPU, such as a modem for communication with the network 106. If the connection of the user terminal 104 to the network 106 via the network interface 202 is a wireless connection, then the network interface 202 may include an antenna for wirelessly transmitting signals to the network 106 and wirelessly receiving signals from the network 106. Any other input/output device capable of providing data or extracting data from terminal 104 may also be connected to the CPU. The above mentioned input/output components may be incorporated into the user terminal 104 to form part of the terminal itself, or may be external to the user terminal 104 and connected to the CPU 230 via respective interfaces. The user terminal further comprises buffers 224a and 224b. The buffers are shown in FIG. 2 as software elements running as part of the processor, however they could also be hardware elements separate from the central processor and connected thereto. The buffers 224a-b are shown as separate from the operating system (OS), however in alternative configurations they could run on the OS. The buffers of FIG. 2 are shown as separate entities to the communication client running on the OS, however in other configurations the buffers may form part of the communication client itself and thus run on the OS within the client. Both buffers are buffers on which data can be stored after being received from one component of the user terminal and before being relayed to another component of the user terminal 104. Buffer 224b is a microphone buffer connected to the microphone 220 and configured to store the audio data captured by the microphone before being further processed. The buffer 224b may also be a component of a soundcard for an audio data buffer, or of a graphics card for a video data buffer.

Buffer 224a is a transmit buffer where data, having been formed into data packets for transport, awaits being passed on to the network interface 202 where it is formed into network layer packets such as IP packets. The transmit buffer 224a stores packets following processing comprising encoding the packets. Controller 226 connects to the buffers 224a-b, and is configured to measure the amount of data stored or buffered in the buffers 224a-b at any one time. The controller may be connected to one or a plurality of buffers and measure the buffered data in any number of these at any time. As such the controller is able to determine and instigate (i.e. through connections to the CPU 230 not shown in FIG. 2), the need for any possible further processes to be carried out in dependence on the measured amount of data in the buffers 224a-b. For example, adapting the payload of packets to accommodate larger amounts of media stream data. Such an adaptation may depend on the controller measuring an amount of buffered data which is at least two or more samples or frames of the live media stream.

The OS 228 is executed on the CPU 230, where it manages the hardware resources of the computer, and handles data being transmitted to and from the network 106 via the network interface 202. Running on top of the OS 228 is the communication client software 222. The communication client 222 handles the application layer data and serves to formulate the necessary processes required to carry out the communication event. For example, the communication client 222 can be arranged to receive input data from the microphone 220 for converting into audio frames for further transport and transmission purposes. The communication client 222 may also supply the necessary information for addressing data packets so that they reach their intended recipient at the receiving terminal 110.

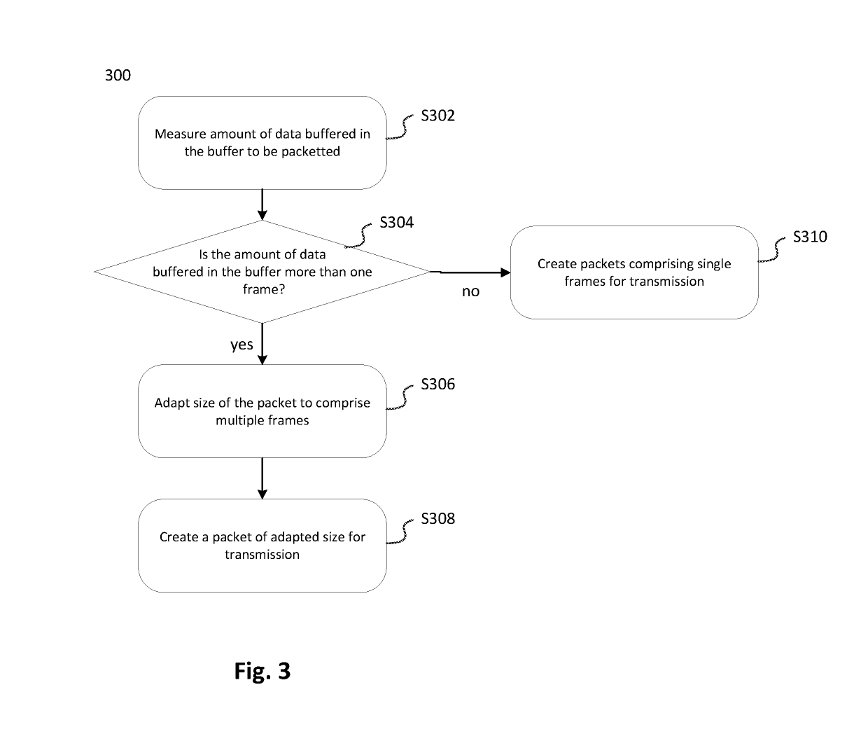

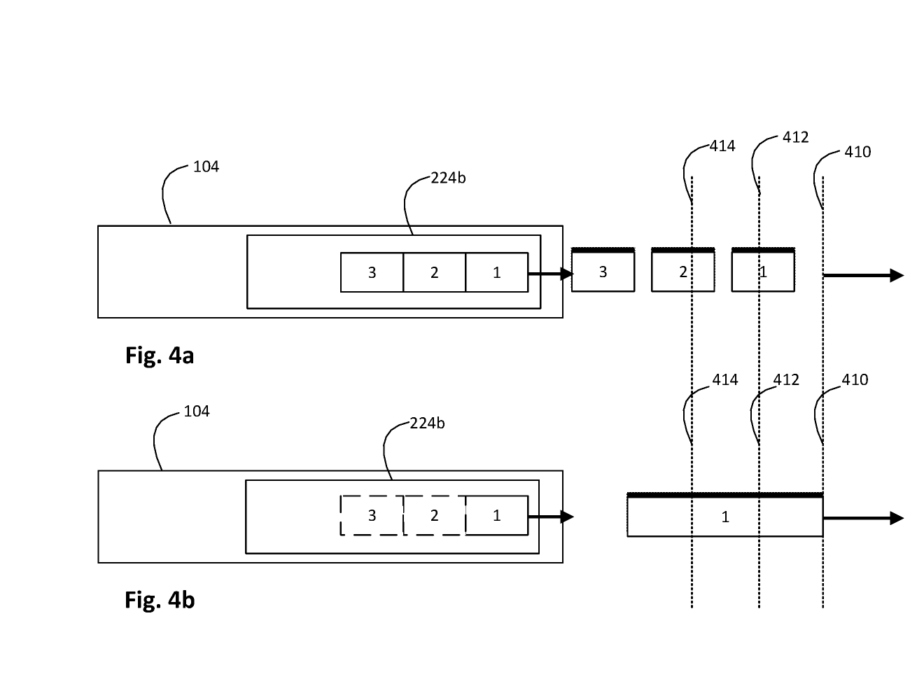

With reference to FIGS. 3 and 4 there is now described a method for adapting the size of a packet of media stream data dependent upon the amount of data buffered in the media capture buffer.

FIG. 3 is a flow chart for a process 300 of measuring an amount data buffered in the buffer, and to adapt the size of the payload of the packet dependent on the measured amount.

The process 300 starts at step S302 whereby controller 226 measures the amount of data buffered, for example in the capture buffer 224b. This could be measured in total media time, total number of media samples or frames, or total number of data packets.

The process then proceeds to step S304 where the controller determines whether the measured amount of buffered data exceeds the amount that would normally be required to form two or more packets of typical size. That is to say has enough media data entered the capture buffer such that in normal processing settings two or more packets would be used for its transport. Typically, a single frame or sample of media stream data would be contained in a single packet. If the media data were audio data for example, the audio frame typically comprises 20 milliseconds of audio data, i.e. data representing 20 milliseconds of sound. However, it should be noted that the time length of the audio data within a frame is not important and can be of any desired or programmed duration in its played out form. Lengths of 10 ms, 5 ms, 30 ms, etc would work in exactly the same way given an environment which supports such frame sizes.

If the answer to step S304 is ‘no’ then the process proceeds to step S310. As there is not a sufficient amount of data in the capture buffer, no adaptation will be made to the size of the packets leaving the buffer, and the packets that are created are of the typical single frame size.

If the answer to the question at step S304 is ‘yes’ then the process proceeds to step S306. There is a sufficient amount of data in the buffer and the controller 226 is configured to adapt the size of the packet. The sufficiency of the amount of data dependents only upon its relationship to the size of a frame or sample (i.e. the size of a typical packet), and may therefore in reality be of any quantitative value. In one embodiment it is an amount of at least an integer multiple of a single frame or sample.

In another embodiment the amount of buffered data may be a percentage based amount, whereby the measured amount is sufficient to result in packet size adaptation if it is at least over a threshold percentage of the size of a frame or sample. In another embodiment the amount of buffered data may have to at least exceed an integer multiple of a frame or sample of data by a threshold percentage. That is to say if a typical single packet contains 20 ms of media stream data, a sufficient amount may be any integer multiple of this, e.g. 40 ms, 60 ms, 80 sm, 100 ms, etc. It may be that the required amount to trigger the adaptation of the packet size is a percentage, e.g. 100%, 200% etc. It may be that the amount must exceed a combination of the two, e.g. be a percentage above an integer multiple. For example, at least 110%, or 210%, or 120% or 220%.

The process 300 then moves onto step S308 where a packet is created with the adapted size dependent on the amount of data buffered in the capture buffer.

FIG. 4a and FIG. 4b are schematic illustrations of the adaptation of packet size in response to the amount of buffered data.

FIG. 4a shows user terminal 104 consisting of at least one capture buffer 224b. The capture buffer 224b containing an amount of buffered data corresponding to three full frames of media stream data 1, 2, and 3, as well as some excess 4. This data is queued in the buffer 224b awaiting packetization for further processing. FIG. 4a illustrates the typical method carried out where each frame of data becomes the payload of a packet where corresponding header information is also added. Each of frames 1, 2, and 3 are shown contained within individual packets having a thick band at the top representing the corresponding header information. Dotted lines 410, 412, and 414, indicate the relative time of transmission of the frames 1, 2, and 3 respectively.

FIG. 4b shows the same user terminal as in FIG. 4a. However, this time the frames 1, 2, and 3, the controller having detected the amount of data in the buffer, are collected into a single packet. This single packet has a single header. As FIG. 4b shows, by consolidating the available data into a single packet containing multiple frames of data, only one header is needed and only a single packet then needs to be transmitted. The data of frame 2 and frame 3 can also be seen to be transmitted sooner when compared to the same frames in FIG. 4a.

By eliminating the multiple instances of packet header overhead in situations when the data of multiple packets is already available at the buffer at the time of forming the first packet, significant time savings can be made in transmitting the frames of data. Such time savings can be beneficial when sending packets in networks for the purposes of real-time communication. Any delay which may be perceived at the receive side of the communication can cause adverse effects in the user experience. For example, increases in adaptive receive and jitter buffers introducing extra delays. By containing more information within a singularly headed packet, delays in transmission can be minimized along with resulting adaptations in receive buffer size.

If the amount of data buffered in the buffer is a large amount, that is an amount which is enough for multiple payloads, there will be latency incurred when processing the data into multiple packets. A single packet with a large payload is usually avoided due to increased latency. That is to say large in the sense that if a typical packet contains one frame of e.g. 20 ms per packet, a large payload might be two frames totaling 40 ms, or three frames totaling 60 ms, etc. There is no requirement that the frame or sample is 20 ms as previously discussed. The usual latency incurred when using larger packets is from waiting for the larger amount of data to arrive needed to form the larger payload. Thus the latency usually incurred by having a large payload for a single packet becomes less of a deterrent as there is already a large amount of data in the buffer. Further there is little point in avoiding making packets with a large payload to avoid increasing the latency when the latency is already increased by the build-up of buffered live media stream data which will incur multiple instances of header overhead and further increase the delay. Therefore, although the buffer may normally provide data in frames of 20 ms per packet, if there is for example 100 ms buffered in the buffer the payload may be increased from 20 ms to 100 ms. Put another way the controller can cause the encoder of the content of the buffer, often called a codec, to make a packet with 100 ms of payload. In the case where a single frame or sample is 20 ms, 100 ms would equate to a payload of 5 frames or samples instead of 1 frame or sample of 20 ms.

The amount of data in the buffer need not be an exact value in order to instigate the adaptation of the packet size. The amount of data measured to be in the buffer is only require to be enough for an integer number of payloads. For example, if the buffer contains >40 ms or >2 frames or samples the payload can be adapted to equal 40 ms or 2 frames or samples. If the buffer contains >80 ms or >2 frames or samples the payload can be adapted to equal 80 ms or 4 frames or samples.

In some cases, a codec may be more efficient when encoding packets with large payloads. That is to say packetizing a larger payload may be more efficient than packetizing a smaller payload. For example, packetizing a payload of 80 ms may be more efficient than packetizing a payload of 20 ms.

The media data type of the live media stream can be any of audio data, video data, or game data. More specifically the live data could be call data and/or TV broadcast data. The call data being data corresponding to a communication transmitted over a network. The network may be a network like the Internet. The call may be a Voice Over Internet Protocol or VOIP call. The call data may be the data of a video call.

In a further embodiment the above described process could be carried out in a buffer at a server. In this case the server performs a relay node function and the measuring comprises measuring the amount of media stream data in a buffer of the server. The buffered data at the relay node may be encoded already and may therefore need to be transcoded (decoded and re-encoded), to enable the packet duration to be made longer. In conferencing (3 or more participants), performing the process at a relay or server can be more complex as the transcoding is likely to already be done if mixing happens at the relay node (server). This can be done (for example in audio mixing), by decoding the streams, mixing and then encoding a new stream of packets. In that case the packet duration can be increased if all the active speakers have queued up data packets. However, in this example case it is required not to let anyone else joint the conversation as an active speaker during this time. The same overall method applies at the relay node as it does for the client of the user device as explained above.

It should be understood that although embodiments herein are described predominantly in relation to audio data, the method and apparatus described herein relates equally to any type of media data capable of aggregating at a buffer. For example, this may be as a result of an internal processing delay, such as a CPU or thread stall, whilst carrying out any processing relating to that media data. For example, the aggregation of video data in a video capture buffer, subsequently resulting in the ability to carry out the above described method and process the video data into packets with a larger payload. In another example the aggregation of game data in a media data buffer, subsequently resulting in the ability to carry out the above described method and process the game data into packets with a larger payload.

It will be appreciated that the above embodiments have been described by way of example only. More generally, according to one aspect disclosed herein there is provided a transmitting device may comprise a buffer for buffering data representing a live media stream to be packetized, and a controller configured to packetize the live media stream from the buffer for processing and then transmission over a network. Wherein the live media stream to be packetized comprises one or more samples or frames of live media stream data, and wherein each of the packets contain one or more of the samples or frames of live media stream data. Wherein the controller is further configured to measure the amount of data buffered in the buffer and to adapt the size of the packets in dependence on the measured amount.

The device may further comprise the controller being configured to adapt the size of the packet in integer multiples of samples or frames.

The device may further comprise the controller being configured to adapt the size of the packet based on the measured amount being at least two or more samples or frames of the live media stream.

The device may further comprise the controller being configured to adapt the size of the packets based on an indication of CPU load.

The device may further comprise the media of the live media stream being audio data.

The device may further comprise the media of the live media stream being video data.

The device may further comprise the media of the live media stream being call data.

The device may further comprise the media of the live media stream being TV broadcast data.

The device may further comprise the media of the live media stream being game data.

The device may further comprise the sample or frame of live media data being 20 milliseconds in length.

The device may further comprise the buffer being a capture buffer configured to buffer the captured live media stream from a media input device, and said processing comprises encoding the packets prior to said transmission over the network.

The device may further comprise a transmit buffer configured to store the packets following said processing comprising encoding the packets.

The device may further comprise the capture buffer being a microphone buffer configured to capture the audio data from a microphone.

The device may further comprise the capture buffer being a video buffer configured to capture the video data from a camera.

In an embodiment a method may comprise buffering, at a buffer, data representing a live media stream to be packetized. Packetizing a live media stream from the buffer for processing and then transmission over a network. Wherein the live media stream to be packetized comprises one or more samples or frames of live media stream data, and wherein each of the packets contain one or more of the samples or frames of live media stream data. Measuring the amount of data buffered in the buffer; and then adapting the size of the packets in dependence on the measured amount.

The method further comprises adapting the size of the packet in integer multiples of samples or frames.

The method further comprises adapting the size of the packet based on the measured amount being at least two or more samples or frames of the live media stream.

The method further comprises adapting the size of the packets based on an indication of CPU load.

The method further comprises buffering being performed by a capture buffer configured to buffer the captured live media stream from a media input device, and said processing comprises encoding the packets prior to said transmission over the network.

In an embodiment a computer program product comprising code embedded on computer-readable storage and configured so as when run on said user terminal to perform any of the method stated above.

Generally, any of the functions described herein (e.g. the functional modules shown in FIG. 2 and the functional steps shown in FIG. 3) can be implemented using software, firmware, hardware (e.g., fixed logic circuitry), or a combination of these implementations. The modules and steps shown separately in FIGS. 2 and 3 may or may not be implemented as separate modules or steps. The terms “module,” “functionality,” and “component” as used herein generally represent software, firmware, hardware, or a combination thereof. In the case of a software implementation, the module, or functionality represents program code that performs specified tasks when executed on a processor (e.g. CPU or CPUs). The program code can be stored in one or more computer readable memory devices. The features of the techniques described herein are platform-independent, meaning that the techniques may be implemented on a variety of commercial computing platforms having a variety of processors. For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Computer-readable storage media do not include signals per se. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A transmitting device comprising:
a buffer for buffering data representing a live media stream to be packetized; and
a controller configured to packetize the live media stream from the buffer for processing and then transmission over a network, wherein the live media stream to be packetized comprises one or more samples or frames of live media stream data, and wherein each of the packets contain one or more of the samples or frames of live media stream data; and
wherein the controller is further configured to measure the amount of data buffered in the buffer and to adapt the size of the packets in dependence on the measured amount.

2. The transmitting device of claim 1, wherein the controller is configured to adapt the size of the packet in integer multiples of samples or frames.

3. The transmitting device of claim 1, wherein the controller is configured to adapt the size of the packet based on the measured amount being at least two or more samples or frames of the live media stream.

4. The transmitting device of claim 1, wherein the controller is configured to adapt the size of the packets based on an indication of CPU load.

5. The transmitting device of claim 1, wherein the media of the live media stream is audio data.

6. The transmitting device of claim 1, wherein the media of the live media stream is video data.

7. The transmitting device of claim 1, wherein the media of the live media stream is call data.

8. The transmitting device of claim 1, wherein the media of the live media stream is TV broadcast data.

9. The transmitting device of claim 1, wherein the media of the live media stream is game data.

10. The transmitting device of claim 1, wherein the sample or frame of live media data is 20 milliseconds in length.

11. The transmitting device of claim 1, wherein the buffer is a capture buffer configured to buffer the captured live media stream from a media input device, and said processing comprises encoding the packets prior to said transmission over the network.

12. The transmitting device of claim 1, wherein the transmitting device further comprises a transmit buffer configured to store the packets following said processing comprising encoding the packets.

13. The transmitting device of claim 11, wherein the capture buffer is a microphone buffer configured to capture the audio data from a microphone.

14. The transmitting device of claim 11, wherein the capture buffer is a video buffer configured to capture the video data from a camera.

15. A method comprising:
buffering, at a buffer, data representing a live media stream to be packetized;
packetizing a live media stream from the buffer for processing and then transmission over a network, wherein the live media stream to be packetized comprises one or more samples or frames of live media stream data, and wherein each of the packets contain one or more of the samples or frames of live media stream data;
measuring the amount of data buffered in the buffer; and
adapting the size of the packets in dependence on the measured amount.

16. The method of claim 15, wherein the adapting the size of the packet is performed in integer multiples of samples or frames.

17. The method of claim 15, wherein the adapting the size of the packet is based on the measured amount being at least two or more samples or frames of the live media stream.

18. The method of claim 15, wherein the adapting the size of the packets is based on an indication of CPU load.

19. The method of claim 15, wherein the buffering is performed by a capture buffer configured to buffer the captured live media stream from a media input device, and said processing comprises encoding the packets prior to said transmission over the network.

20. A computer program product comprising code embedded on computer-readable storage and configured so as when run on said user terminal to perform the method of claim 15.
